(19) United States
(12) Patent Application Publication
(10) Pub. No.: US 2002/0107770 A1
(43) Pub. Date: Aug. 8, 2002

(54) System for allocating funds in a plurality of stock portfolios

(76) Inventors: Chadwick M. Meyer, Chicago, IL (US); Thury L. Foster, Chicago, IL (US)

Correspondence Address: DICKINSON WRIGHT PLLC, 1901 L Street, N.W., Suite 800, Washington, DC, 20036, US

(21) Appl. No.: 09/734,923

(22) Filed: Dec. 13, 2000

Related U.S. Application Data
(60) Provisional application No. 60/203,931, filed on May 12, 2000.

(51) Int. Cl. G06F 17/60

(52) U.S. Cl. 705/36

(57) ABSTRACT

The invention relates to a computer operated system that enables online investors to buy and sell stocks via individual hybrid stock/mutual fund portfolios containing a preselected number of holdings selected by a portfolio manager. The system contemplates using a host website that displays the stock portfolios that are offered and the percentage that each holding represents of the total value of each one, along with information about the portfolios and holdings therein. The system preferably enables investors to become registered account holders, such that when a purchase or sale transaction is made, the appropriate number of shares of stock can be allocated into the appropriate investor accounts. The portfolio managers are able to adjust the content of each portfolio, including the holdings and the percentage that each holding represents of the total value of each one, wherein the adjustments are able to be automatically allocated into the investor accounts. The system comtemplates being able to make purchase and sale transactions at predetermined times to obtain volume discounts from stock clearing houses.

### RELATED APPLICATIONS

This application claims priority from U.S. Provisional Application Serial No. 60/203,931, Which was filed on May 12, 2000.

### FIELD OF THE INVENTION

The present invention relates to the field of computer operated investment tools, and in particular, to a method and apparatus for providing a plurality of stock portfolios on an electronic communications network and allocating funds therein.

### BACKGROUND OF THE INVENTION

Stock trading, it seems, has become a national pastime in recent years. In fact, instead of quoting baseball and football scores at the water cooler these days, today's workers are quoting stock prices and talking about things like public offerings, stock options and P/E ratios, etc. The lure of money and getting rich quick by investing in the stock market has, it seems, become part of the American way of life.

This aspect has become increasingly common largely due to certain advancements in technology, including the ability of investors to buy and sell stocks online. “Online trading” has enabled individual investors to invest without having to pay what were thought to be absurdly high brokerage fees, using their own personal computers and network connections. Indeed, in this respect, “day trading” has become popular among certain circles, wherein investors have dispensed with the traditional notion of pursuing long term gains, and instead, opting to cash in on minute-to-minute stock price fluctuations, in hopes of achieving instant gains.

While the wave of economic prosperity and rising stock prices of the late 1990's have made it seem (at least to some) almost impossible for the average investor to lose money, the reality is that many investors are losing money, lots of money, despite the overall trend. One reason for this is the lack of effort that many investors are making to educate themselves about the choices they are making and the companies they are selecting to invest in. In this respect, most individual online investors are, at best, part time investors with only money on their hands, and little time, skill or discipline needed to make sound investment decisions. They often take the easier route of relying on stock tips from friends, acting on hunches or emotion, or speculating on future performance based on past results.

In contrast, a popular alternative to investing in individual stocks has been the mutual fund. For the very same reasons discussed above, many investors buy shares of mutual funds and let experienced fund managers make important investment decisions for them. Mutual funds are essentially an asset pool consisting of investments in securities that are chosen by the fund manager, which allow individual investors to buy into and obtain an interest in the fund, such that when the securities in the fund do well, the fund, and therefore, the investor, also does well.

While there are some advantages to investing in mutual funds over individual stocks, as discussed above, there are also some disadvantages. First, while mutual fund managers buy and sell stocks throughout the year, the tax consequences that result from each transaction are passed through to the fund shareholders (who own a partial interest in the fund) at the end of the year. This can result in a situation where a purchaser who buys into the fund near the end of the year can be required to pay taxes on gains occurring throughout the year, even those occurring before the purchaser bought into the fund.

Second, there are significant expenses associated with operating a mutual fund that must be paid from the asset pool, i.e., from the earnings of the fund, and therefore, can lead to a reduction in the shareholders' earnings. For example, every mutual fund must pay investment fees to the fund manager, custodian fees to the custodian, accounting fees, shareholder servicing fees, audit fees, and legal fees, etc. These expenses can significantly reduce the earnings of the fund, and therefore, can result in reduced earnings to the investor.

Third, much of the operating expenses discussed above are not proportional to the size of the fund. That is, the ratio of expenses to assets can be disproportionately high in small mutual funds, thereby giving them a disadvantage when compared to large mutual funds. Large mutual funds can also purchase securities in larger quantities, and therefore, can leverage higher discounts on commissions and obtain higher yields on bonds and other debt securities. These circumstances make it difficult for new start-up and small mutual funds to succeed.

Fourth, the fees, as a percentage of assets, paid by investors to buy mutual fund shares are not allowed by law to be adjusted by the seller on the basis of the amount of assets purchased. That is, the percentages are required to be the same across the board regardless of the amount invested. For example, by law, the fees cannot be adjusted in a manner that would result in an investor who invests a relatively large amount of money to pay lower fees as a percentage of assets than an investor who invests a relatively small amount of money.

Lastly, most mutual funds contain a large number of holdings. For example, of the 10,000 or more mutual funds that exist today, only about 200 of them have fewer than 60 holdings each. Yet, reports have indicated that no more than about 16 holdings are typically required to achieve the appropriate amount of diversification needed to protect a fund. What this means is that in most mutual funds, even when there are significant gains in a small number of holdings, those gains do not necessarily result in significant gains to the fund.

### SUMMARY OF THE INVENTION

The present invention relates to a system that provides online investors an alternative to buying and selling individual stocks and mutual funds, by offering individual hybrid stock/mutual fund portfolios that contain a preselected number of holdings (preferably less than 20 to 30 chosen by a portfolio manager), wherein each holding represents a percentage of the total value of each portfolio. The manager(s) of each portfolio select the holdings, and the percentage that each holding represents of the portfolio's total value, and then monitors the holdings (and the market) to determine when and to what extent changes should be made. In this respect, the portfolio manager is able to centrally control the individual stock portfolios of potentially thousands of clients. The stock portfolios of the present invention are unlike mutual funds because the individual investor owns stock in each holding, whereas, in the case of mutual funds, the investor owns only a fractional interest in the pooled assets of the fund (not the stocks themselves). In this respect, the present invention is able to provide individualized accounting and tax implications, as well as performance and expenses, which mutual funds do not.

The portfolios of the present invention are preferably offered via a global communications network, such as the world wide web, wherein online investors are able to view and select from a number of stock portfolios that are offered using their own personal computers and network connections, etc. The host's website preferably displays the portfolios that are available, the specific holdings that are contained in each portfolio, and the percentage that each holding represents of each portfolio's total value. The website also preferably provides additional information about each portfolio, including the names of the managers, the portfolios' objectives, expenses, risk tolerance levels, past performances, whether they consist of small, mid or large cap, growth or value, international or domestic, etc. Additional information about each holding can also be provided, either on the site or via links from the site.

The website preferably enables payments to be processed and accounts to be set up online. For example, the system can be provided with a full service payment processing application which enables customers to use credit cards or other financial accounts to make payments, and for them to be carried out quickly. At the same time, the system preferably enables the host operator to verify the credit history of each investor, as well as other relevant information, so that the credit risks can be determined before the transactions are made. In this respect, the system preferably requires each investor to be pre-approved before any transactions are made. Once approved, the investor is given an account and authorization to access the trading section of the site to conduct transactions up to a specified limit. The system also contemplates that investment money accounts can be set up in which deposits can be made, wherein payments can then be withdrawn directly from the accounts.

Online investors are able to view the portfolios that are available and select which ones to invest in, and how much to invest in, using the web site. For example, if there are 30 different stock portfolios offered, an investor may decide to invest $5,000 in one portfolio, and $10,000 in another. These decisions can be based on a number of factors, including the risk tolerance levels and preferences that each investor may have, as well as other information provided on the website about the portfolios. The selections are preferably made simply by clicking onto the desired portfolio(s), and indicating the amount(s) to be invested in each one, and then sending in the order(s).

Once investors make their selections, the system preferably calculates the total number of shares of each holding to buy on a daily basis. It does so based on the total amount invested by all investors who have placed orders that day, the portfolios that have been selected, the amount invested in each one, and the percentage by value that each holding represents within each portfolio, which has been previously determined by the portfolio manager. The total number of shares that would have to be purchased for any given holding on any given day depends on the purchase price of the stock at the time, and how many shares would be needed to make up the total value of the holding within the portfolios that are purchased or sold. In this respect, the present system contemplates that fractions of shares can be allocated and distributed to each investor account so that the total value of each holding within each account can equal or nearly equal the percentages that they represent in the portfolios that are purchased (as determined by the portfolio managers).

The host environment is preferably linked to one or more stock clearing houses which enables stock purchases and sales to be made quickly and automatically online. The system preferably waits until enough orders have come in to maximize the volume discounts that can be obtained. When enough orders have come in at the end of the day, the system automatically buys and/or sells the appropriate number of shares of stock, as represented by the selected portfolios, so that each customer will then own the appropriate number of shares. When only a few orders, or small orders are placed, such that the volumes on any given day are relatively small, the system preferably maintains enough stock within its own holding account so that the proper amounts can be allocated and distributed to each account holder accordingly.

Only one transaction is preferably made for each holding each day so that the highest possible volume discounts from stock clearing houses can be obtained. In this respect, the system contemplates that large blocks of stock for each holding can be purchased as volumes increase, thereby reducing the expense of operating each portfolio. Any shares that are left over after allocating and distributing the holdings to the individual investor accounts can be held in the host operator's own holding account, wherein this supply can then be used to fulfill future orders that are relatively small.

Once the transactions have been carried out, the stock to be owned by a particular investor is allocated and placed into his or her account. In such case, each investor then owns the precise number of shares of each holding in proportion to the percentage that that holding represents within the portfolio purchased (although title remains in the broker or dealer's street name). For example, when an investor invests money in a portfolio that he or she already owns, the number of shares that the investor then owns of each holding in the portfolio is proportionately increased to match the percentage that that holding then represents of the total value of the portfolio. That is, if an investor doubles the amount invested in an existing portfolio, each holding in the portfolio would be increased by 100%. The result is that the investor would then own each holding in the same proportions to each other as before the purchase. The account that has been set up for each investor preferably enables the investor to review the holdings that have been purchased in the account, as well as the number of shares that have been purchased or sold, the current value of the holdings, and a record of all past transactions, deposits and withdrawals, which can be reviewed online at any time.

When a customer decides to sell, he or she can log onto the web site in the conventional way and can then view the portfolios that are in his or her account, wherein a prompt can be provided which enables the investor to select which portfolios to sell, and how much to sell of that portfolio's current value. For example, if one of the portfolios in the account has a current value of $5,000, he or she can choose to sell the entire portfolio, or any portion of it, simply by clicking onto the desired portfolio, and indicating the amount to be sold, and then sending in the order. Again, these decisions can be based on a number of factors, including market factors, personal circumstances, risk tolerances and preferences, etc.

As with purchase orders, when a sale order is submitted, the system preferably calculates the total number of shares of each holding to sell based on all of the orders placed that day. The system preferably does this by waiting until enough orders have come in, and then taking into consideration all of the portfolios that have been selected for sale that day, the amounts to be sold of each one, and the percentages by value that each holding represents within each portfolio to be sold. In this respect, the total number of shares to be sold on any given day depends on the purchase price of the stock, and how many shares would need to be sold to result in the total value of that holding within those portfolios.

As is most often the case, when both purchase and sale transactions occur (with respect to any given holding) on the same day, the system preferably determines, for any given holding, the difference between the total number of shares to be purchased, and the total number of shares to be sold, wherein it can then determine how many shares of any particular holding need to be bought or sold that day. In this way, the system preferably buys or sells only enough shares of any particular holding (from the clearing house) to fulfill the orders placed that day, whether a purchase or sale, without creating any excess or deficiency of shares of any particular holding. That is, by being able to transfer shares from one account (when a particular holding is sold) to another account (when a particular holding is purchased), the system can efficiently process purchase and sale transactions every day.

Whenever one of the portfolio managers decides to change a portfolio, he or she can decide what changes need to be made to the holdings, and/or what changes need to be made to the percentages that each holding represents in the portfolio. For example, the portfolio manager may decide to reduce by 50% the value of one holding in the portfolio, and to proportionally increase the value of another holding in the portfolio. These changes can be brought on by any number of factors, including a change in a particular holding's performance, expectations, management, as well as changes in the overall market, oil and gas prices, interest rates, market trends, currency rates, threats of war or strike, etc.

When a portfolio manager decides to change a portfolio, the system preferably enables the changes to be made system-wide automatically, i.e., in every account containing that portfolio, with a single action. This is preferably accomplished by having the system conduct a combination of purchase and sale transactions based on the changes that have been made by the portfolio manager. For example, for any specific holding, upon instructions from the portfolio manager, the system can sell shares of a particular holding (either the entire holding or portion thereof) such that the appropriate number of shares held within the existing accounts can be adjusted in proportion to the percentage that that holding represents within the portfolio after the change. The proceeds from that sale are then either allocated back into each account as cash (in proportion to the amount originally invested), or reinvested.

When the portfolio manager decides to reinvest the proceeds and buy additional shares of stock (either to increase an existing holding or buy a new holding), the same system-wide approach can be used. That is, the portfolio manager decides which holdings to purchase, and what percentage that that holding will represent in the portfolio after the change is made. The system will then automatically calculate and carry out the necessary transactions so that the changes desired by the portfolio manager are achieved. Again, these transactions are performed so that every account affected by the change will automatically reflect the changes. An email message will then preferably be sent to each account holder regarding the change.

The present invention contemplates that fees can be charged to each investor who chooses to purchase or sell stock portfolios offered by the system. The fees can be based on the amount of assets that a particular investment involves, i.e., a percentage of the assets. The fees can also be adjusted so that an investor who invests a relatively large amount of money is required to pay lower fees as a percentage of assets than an investor who invests a relatively small amount of money, unlike mutual funds which cannot by law.

In addition to the above, the present invention contemplates offering customized portfolios designed from a database of prescreened stocks and mutual funds according to the investors' preferences. The investor is preferably prompted to fill out an online questionnaire so that his or her objectives and preferences can be determined, such as time until retirement, risk tolerance levels, objections to certain industries (i.e., tobacco or alcohol), preference for others, amount to be invested, the desire for tax management, etc. Once the data for each has been collected, the system will determine a custom portfolio according to their preferences, and the system will continue to manage the portfolios according to those preferences.

### BRIEF DESCRIPTION OF THE DRAWINGS

FIG. 1 is a flow-chart showing the portfolio manager's responsibilities;

FIG. 2 is a flow chart showing the client access, registration and account formation process;

FIG. 3 is a flow-chart showing the stock purchasing process from the client's side;

FIG. 4 is a flow-chart showing the stock selling process from the client's side;

FIG. 5 is a flow-chart showing how orders are processed by the system;

FIG. 6 is a flow-chart showing how adjustments are made by the system;

and

FIG. 7 is a flow-chart showing how customized portfolios are processed by the system.

### DETAILED DESCRIPTION OF THE INVENTION

The present invention essentially runs on a computer operated “host” environment which consists of one or more servers that can be accessed by using a global network such as the world wide web. The host environment allows online users to use a personal interface to access the host website and then become registered account holders, wherein the user is able to view hybrid stock/mutual fund portfolios and information about them to decide whether to invest.

The host environment is comprised of information about the portfolios, and can be programmed by the host operator to describe the portfolios that are being offered, and the content of those portfolios and why they are being offered. The host operator preferably consults money managers who select the stocks for each portfolio, wherein the portfolios are then designated by what type of portfolio it is, and what type of investor it is geared to. For example, various portfolios can be designated, without limitation, in any of the following ways: large cap, mid cap, small cap, technology stocks, growth stocks, value stocks, diversified stocks, domestic stocks, international stocks, etc., and can be designated as being targeted to high risk, moderate risk or low risk investors, etc.

The system's connection to the global network allows any online user to access the host environment so that he or she can learn about the various portfolios that are available and what the stock selections are based on. Each portfolio not only shows what the percentage allocated for each holding is, but also preferably tracks the history of each stock, with a brief explanation as to why the stock was chosen. The bundle of information provided for each portfolio is intended to be comprehensive enough to enable customers to make sound investment decisions, but not so overwhelming that it would be too confusing or difficult for the average online investor to understand. In this respect, the system is intended to provide educational information of a general nature, and specific information about each portfolio, wherein the combination of information is intended to help investors make important decisions quickly. The low total number of stocks in each portfolio is also intended to help to reduce the need to review too much information which can be difficult for the average person.

The System Architecture

The system architecture of the present invention generally comprises a network having a network interface, along with one or more servers and databases, etc. The system comprises an interface via the global network through which electronic access can be made. The interface is intended to enable virtually anyone connected to the global network to connect to the host environment. The interface is preferably connected via a public switched telephone network, such as those provided by a local or regional telephone operating company. Connections may also be provided by dedicated data lines, cellular, personal communications systems, microwave or satellite networks. Internal or external modems can serve as the network interface. In the preferred embodiment, the network interface is connected to a global network, such as the world wide web, which is made accessible to others via a commercial online service, such as America Online.

The network interface is the gateway for communications and transactions between the host environment and auxiliary entities, including payment processing applications, stock clearing houses, portfolio managers, online customers, etc. In this manner, the applications and functionalities of the system preferably flow from the host environment, via the global network, to the other entities (who can gain access to the host website using browsers). The general public is given access to the home page, but only registered users who are validated and authenticated are given access to the private trading sections of the site and the individual accounts. Only the host operator is given access to the administration page of the site, and portfolio managers are given access to sections that enable them to create and change the portfolios that they manage.

A firewall (i.e., such as made by Checkpoint™) is preferably provided between the network interface and servers to provide security for the system. This firewall preferably allows access by regular users of the host environment, while preventing hackers and others from infiltrating the servers in the network. Firewalls that can be set to close off the network from everyone except those specified by the host operator are preferably used to enable flexibility. Also, the preferred firewall logs suspicious events and alerts system administrators when attempts are made to breach security.

The present system network preferably comprises web and database servers which can be separately provided to ensure that capacity is sufficient and expandable. While it may be possible for a single computer or server to act as a central controller for all of the system's functions, separate servers can be used to allow the system to expand and be configured for various applications, such as those that have different configuration requirements. For example, separate web, application and data base servers housed in separate units can be provided if desired so that the system is scalable, yielding a more dynamic and flexible system, capable of operating a wider range of applications and being less prone to catastrophic hardware failures affecting the entire system.

In the preferred embodiment, the system utilizes hardware, such as those manufactured by any of the many suppliers in existence today, having the required functionality and capacity. The web server preferably comprises a central processor (CPU), ram, rom, operating system, interface, data storage, disc drives, etc. In this respect, a conventional personal computer or computer work station with sufficient memory and processing capability may be used as the web server, both for receiving and transmitting information through the interface. The web server must be capable of high volume transaction processing, performing a significant number of mathematical calculations in processing communications and data base searches.

Where more than one web server is used, load balancing systems (such as those made by F5 Networks Inc.) and replication and failover systems (such as those made by Veritas Inc.) can be provided to supply traffic management and standby protection for the system. The replication feature enables the applications and other content information stored in one server to be replicated to other server(s) to ensure that nothing is lost. Additional servers can be installed and connected to provide expandability and flexibility, in which case the replication functions enable all of the information to be replicated to the new servers.

The web server is preferably configured to contain the URL addresses of the home page and various administrative pages that are made available to the host operator and others needing to use the system such as the portfolio managers. In this respect, the web server serves as the platform for the web site, and hosts web server applications as is known in the art.

An application server is preferably provided to perform various commerce applications, such as those used to process payments and transactions involving stock purchases and sales. In this respect, the system is preferably compatible with various applications software, wherein the server is configured to run the e-commerce applications that are desirable, such as those that provide real-time quotes online, those that carry out stock purchase and sale transactions, and those that process payments, etc. Because many of these applications have different configuration requirements, more than one application server may be needed. Depending on what commerce applications are employed by the system, an appropriate number of servers may be required, to ensure that each application can be operated without undue reconfiguration and adjustment.

A database server can be provided and dedicated for data base applications (or the database can be provided in connection with the web or application server). If a separate database server is used, it preferably comprises a central processor (CPU), ram, rom, operating system, etc. These servers are preferably capable of being expanded, i.e., to four CPU's, or their capacities can also be expanded, although a conventional personal computer or work station with sufficient memory and processing capability dedicated to data storage can be used if desired. The database server may include hard disk magnetic or optical storage units, as well as CD rom drives or flash memory, etc. The database server preferably contains applications that are compatible with e-commerce applications stored in the application server discussed above. The database server is preferably used to process transactions affecting information stored in the server, including data bases for investor accounts, invoices, transactions, payments, etc. Data base software such as those manufactured by Sybase and Oracle Corporation can be used to create and manage the accounts.

An additional firewall is preferably provided between the web/application server and database server, when applicable, to provide security for the database. This firewall is preferably set up to allow access only to servers on the network, while preventing hacking, tampering and illegal entry to the database in any other manner.

The following are examples of data bases that are stored in the present system:

The account data base maintains data on investors on fields such as name, address, credit card number, financial account, phone number, fax number, e-mail address, etc. This information is obtained when the investor first registers with the system to create an account. The account data base stores information regarding the investor and allows investment accounts to be set up. These investment accounts can store information such as the amount deposited into or withdrawn from the account, which portfolios have been purchased, how much has been invested in each one, the value of the portfolios and holdings in the account, past transaction information, how much money is currently in the account, and any other pertinent information about the account.

The payment data base tracks payments in relation to the investments that are made. The payment processor is an application program that supports the transfer and exchange of payments, charges, debits, etc. The processing of credit card transactions is preferably supported with commercially available software, which can transmit credit card numbers electronically over the internet to servers where card verification and processing can be handled. Such applications can provide services such as online account statements, order taking and credit card payment authorization, credit card settlement, digital receipt generation, account based purchase tracking and payment aggregation, etc.

The order data base tracks the orders that are placed and stores information regarding the orders so that the transactions can be processed at the end of the day, i.e., when enough orders have come in. When enough orders have come in, and when the transactions should be made, are preferably subject to override and determination manually by the host operator. The system also preferably enables various factors to be considered before processing the transactions, such as when a minimum threshold number of orders have come in, and the value of those orders, in which case the system can be programmed to wait until the threshold has been met before conducting the transactions. In such case, the system may decide whether to conduct the transactions that day, or obtain shares from its own holding account. A large number of orders can preferably be placed on hold while the system waits for additional orders before the purchase and sale transactions are carried out.

The portfolio manager database stores information provided by the portfolio managers. This information is provided in connection with the portfolios that they create and manage, and includes supporting information about the portfolios and holdings that are made available to investors. In this respect, the portfolio manager is preferably able to process changes to the portfolios using an interface linked to the system, wherein the database storing that information can preferably be accessed via a link, so that appropriate changes can be automatically made in the system.

The System Method

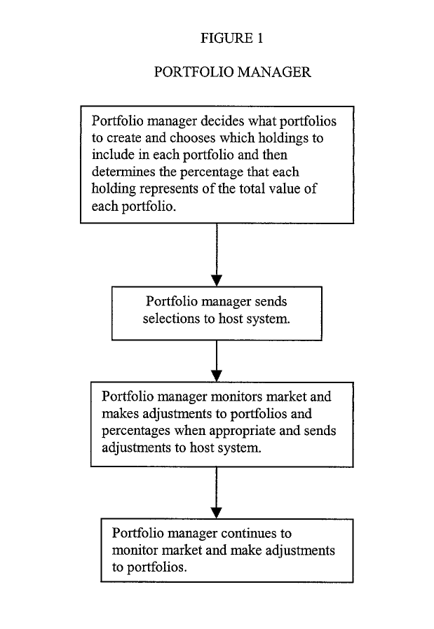

The process begins by having the host operator set up the portfolios that are to be made available to investors, as shown in FIG. 1. In this respect, portfolio managers are used to set up specific portfolios based on specific preferences. Preferably, each portfolio manager will design a predetermined number of portfolios, each containing no more than about twenty to thirty holdings. For example, portfolio manager A may be asked to design three portfolios targeting specific preferences, i.e., high tech, small caps, international, growth, etc. The portfolio manager would then create three different portfolios, each preferably having a specific focus.

The system preferably provides the portfolio manager with a network connection to the host environment so that the portfolio manager can be prompted to create the portfolios and enter specific information about the portfolios that have been created. An interface is preferably provided so that communications can be made directly between the portfolio manager and the host environment, so that whenever a portfolio is created or changed, the information can be transmitted directly to the host via the global network.

The following is an example of three portfolios that could be created (only five holdings are included in each portfolio for ease of demonstration although more are preferred):

| | |
|---|---|
| | Percentage of Total |
| Holdings | Value |

Portfolio I

| | |
|---|---|
| A | 10% |
| B | 15% |
| C | 30% |
| D | 25% |
| E | 20% |

Portfolio 2

| | |
|---|---|
| C | 20% |
| F | 15% |
| G | 15% |
| H | 25% |
| I | 25% |

Portfolio 3

| | |
|---|---|
| D | 25% |
| H | 25% |
| J | 15% |
| K | 15% |
| L | 20% |

The first column of each chart above shows the holdings, and the second column shows the percentages that each holding represents of the total value of each portfolio. For example, in portfolio number one, holding A represents ten percent of the total value of the portfolio, and in portfolio number two, holding C represents twenty percent.

Once each portfolio manager has created his or her portfolios, they can be transmitted to the host environment using the interface and network connection. The information can be input into the system by the host operator if desired. An input program developed for this purpose can be provided. The system can also be configured to create fields that the portfolio manager can complete, such that the information can be downloaded directly from the portfolio manager's computer or terminal using the network connection, wherein no involvement by the host operator would then be needed, except to review the information and approve it.

The system preferably prompts the host operator to select the application format for entering the required information, wherein a display accessible to each online investor via the global network can be created using the system. The information that is displayed on the website can include information about the system and its functions, information about the host operator and company, the names of the portfolio managers that are involved, the objectives of the managers and portfolios, the expenses involved in operating each portfolio, the risk tolerance levels associated with each portfolio, past performances of each portfolio, whether any particular portfolio represents small, mid or large cap investments, growth or value investments, or international or domestic investments, or some combination, charts, etc. The descriptions of each portfolio preferably resemble reports such as those furnished by Morning Star™. Additional information about each holding can also be provided, either on the website, or via links from the site to other web sites. Specific information about each holding, that can be used to create customized portfolios, such as whether it falls within a specific industry (i.e., tobacco or alcohol), can also be entered when prompted, as will be discussed.

There is no specific way in which the web site of the present invention must be set up to enable online investors to view the available portfolios and make their selections. The web site simply needs to provide a list of each of the portfolios that are available, as well as information about the holdings, which would facilitate an investor's decision as to which ones to buy or sell and how much to buy or sell. The presentation of the portfolios on the web site preferably enables each investor to clearly see which holdings are included in each portfolio. This enables investors to clearly see which company's stocks are included and the percentage of those holdings in relation to the portfolio's total value.

The process by which an online investor accesses and places an order will now be described:

The system comprises a homepage that is accessible to the public via the global network. The homepage allows users with browsers to navigate by content, which can include one or more of the following: information about the system, information about the host company, financial news and information of a general nature, links to real time investment information, chat rooms, information about the portfolio managers and other resources in the system, a search capability within the web site, etc. The public site also preferably enables anyone to review the portfolios that are being offered, as well as the percentages that each holding represents of the portfolios, and any other information about the portfolios and holdings.

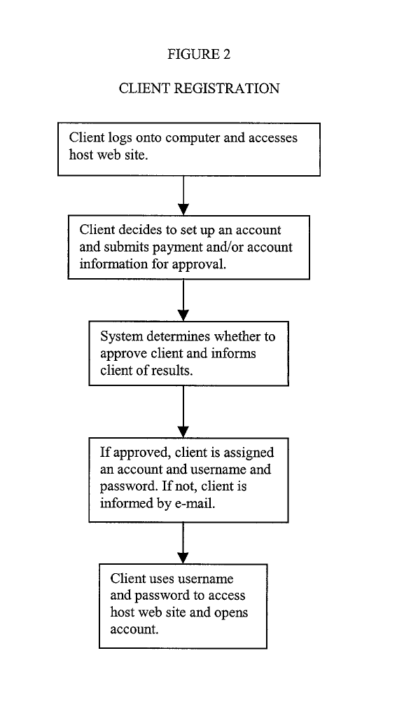

The site also provides a registration page which allows online investors to register and become pre-approved, and to set up individual investment accounts into which money can be deposited to pay for investment transactions, as shown in FIG. 2. The first step of the registration process using the registration page is preferably for the online investor to review an introductory explanation of the registration process, including the terms of service, wherein the online investor can be required to accept a form contract setting forth the terms of service provided on the page. In order for the online investor to create a new account, he or she is prompted to enter basic information, including his or her name, address, phone number, e-mail address, financial billing information, credit card number, etc. Once the information has been entered, the system is preferably capable of verifying that the form has been entered correctly. If the information has not been entered correctly, the invalid fields are preferably shown to enable the investor to make the necessary corrections.

The authorization steps are then performed after the information has been submitted. The financial information submitted by each investor is preferably reviewed via a standard payment processing application (such as Clear Commerce™) that is linked to the system. The linked application enables the credit history and other information of the applicant to be carefully reviewed and then pre-approved if the information is found to be acceptable. The investor is also given the option of creating an interest earning investment account in which money can be deposited and from which money can be withdrawn to pay for investment transactions. The investor can deposit money into the account by mail, wiring, etc., or money can be transferred from the investor's own financial accounts to the investment account.

In the event that authorization is denied, the system informs the investor of that fact, wherein the investor is preferably given another chance to submit information that can be verified. If credit card or other authorization is approved, the system determines the maximum amount that the system will approve for any given transaction on any given credit card, i.e., a credit limit. This helps to limit the amount that any particular investor can invest in without posing undue risk.

Once the investor has been pre-approved, the online investor is informed of this fact. This notification can be done by e-mail, wherein the system can then provide a user I.D. name and password to allow the investor to access the private investment section of the site, and his or her own account. Preferably, the private investment section of the web site and accounts are secured so that only those who have authorization are able to use those sections.

The online investor can then use the I.D. name and password to log into the appropriate section of the web site. The investor can review his or her own account, which includes information about the account and its holdings. The account can be set up to include information such as the amount of money that is currently in the account, records of previous transactions that have occurred, a record of the deposits and withdrawals that have been made, the portfolios and holdings that are in the account, the current value of those portfolios and holdings, etc.

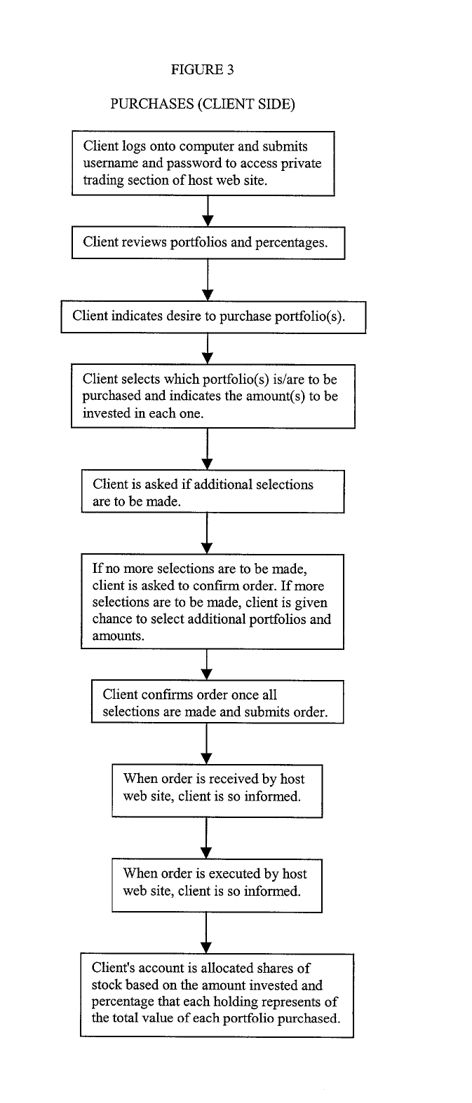

The system also preferably allows the investor to easily review and make selections regarding which portfolios to invest in and how much to invest in each one, as shown in FIG. 3. This is preferably done simply by having the investor click onto the portfolio that is desired (on the screen), and indicating the amount to be invested in that portfolio, i.e., when the investor is prompted to do so. This process can be done using a “shopping cart,” wherein the investor can make more than one selection and can then review them to determine whether the right decisions and amounts have been indicated. Once each of the selections have been made, the investor is prompted to either approve or disapprove the transaction. If there are any errors, or changes are desired, the system preferably enables the investor to make the appropriate corrections.

Once the order has been placed, the order is transmitted via the global network from the investor's interface to the host server, wherein the order is registered in the host database. The system is preferably adapted so that a large number of orders can be received and saved, and then held there until a sufficient number of orders have been placed, i.e., at the end of the day. This enables a large number of orders to be held, during which time the system waits until enough orders have come in to maximize the volume discounts that are available from stock clearing houses linked to the system. Preferably, the system waits until the end of the day when a large number of orders have been received before executing the transactions.

Before executing the transactions, the system preferably calculates how many shares of each holding need to be purchased and/or sold, based on the orders that have been placed that day, and considers any changes that have been made by the portfolio managers. Since a particular holding can be found in more than one portfolio, the system must be capable of screening the orders to determine the total number of shares that need to be bought and/or sold on any given day, based on the percentages that each holding represents in each portfolio that has been purchased or sold (or changed).

For example, with respect to purchase orders, the system preferably screens each order to determine which portfolios have been ordered and the amount invested in each one. The system then uses the percentages that each holding represents (as set by the portfolio managers) in relation to the total value of each portfolio, to determine the total amount that needs to be invested in each holding (for any particular order). Then, the totals from every order placed that day are summed up for each holding to determine the total number of shares that need to be purchased.

The system can do this in a number of ways. For example, in one embodiment, the following steps are used: For any particular holding, the system identifies which portfolios that holding is represented in (as determined by the portfolio managers). Next, the total amount invested that day in each portfolio containing that holding is determined, wherein the percentage that the holding represents within each portfolio is then determined. Then, with respect to each portfolio containing that holding, the total amount invested in that holding is determined by multiplying the total amount invested by the percentage that that holding represents in the portfolio. Finally, the amounts determined for each portfolio containing the particular holding in question are then added up, to determine the total amount that needs to be invested that day for that particular holding.

In another embodiment, the following process can be used: For any given portfolio, the total amount invested from all orders that day is calculated. Next, the percentages that each holding represents in that portfolio are determined, wherein with respect to each holding in the portfolio, the total amount invested in that portfolio is multiplied by the percentage that each holding represents in the portfolio. Then, after this is done for each portfolio, the total amounts for each holding contained in each portfolio are added up, wherein the amount to be invested in any particular holding can be determined.

Using either embodiment, or any similar method, the amount to be purchased of each holding is determined. For example, using the three sample portfolios identified above, if investor one invests $10,000 in portfolio one, investor two invests $5,000 in portfolio two, and investor three invests $20,000 in portfolio three, the system will calculate the total number of shares that need to be purchased of each holding contained in the three portfolios. For instance, using either of the methods described above, the system would calculate the following: the system would have to purchase $1,000's worth of holding A (for investor one), $1,500's worth of holding B (also for investor one), $4,000's worth of holding C (for investors one and two—$3,000 for investor one and $1,000 for investor two), $7,500's worth of holding D (for investors one and three—$2,500 for investor one and $5,000 for investor three), $2,000's worth of holding E (for investor one), $750's worth of holding F (for investor two), $750's worth of holding G (also for investor two), $6,250's worth of holding H (for investors two and three—$1,250 for investor two and $5,000 for investor three), $1,250's worth of holding I (for investor two), $3,000 worth of holding J (for investor three), $3,000's worth of holding K (for investor three), and $4,000's worth of holding L (for investor three). Note that of the holdings listed above, holdings C, D and H are found in more than one portfolio, and therefore, the amounts invested in those holdings need to be added up to determine the total amounts to be purchased by the system.

Here is another example. In the example above, if investor one, in addition to investing $10,000 in portfolio one, invests $10,000 in portfolio two, the following will occur: The system would purchase $1,000's worth of holding A (for investor one), $1,500's worth of holding B (for investor one), $6,000's worth of holding C (for investors one and two—$5,000 for investor one and $1,000 for investor two), $7,500's worth of holding D (for investors one and three—$2,500 for investor one and $5,000 for investor three), $2,000's worth of holding E (for investor one), $2,250's worth of holding F ($1,500 for investor one and $750 for investor two), $2,250's worth of holding G ($1,500 for investor one and $750 for investor two), $8,750's worth of holding H ($2,500 for investor one, $1,250 for investor two and $5,000 for investor three), $1,250's worth of holding I (for investor two), $3,000 worth of holding J (for investor three), $3,000's worth of holding K (for investor three), and $4,000's worth of holding L (for investor three).

Once the value totals (for each holding) that are to be purchased on any given day are known, the system preferably converts them to numbers of shares by using the current price per share then existing at the time of the transaction. This can be done automatically using links to systems which incorporate that information, such as those found in stock clearing houses, real-time quote systems, etc., wherein the total value of each holding needed to be purchased is divided by the price per share, to come up with the total number of shares needed to be purchased.

Once the system determines how many shares must be purchased of each holding (represented in the portfolios purchased), the system generates an order to buy. Preferably, the system can execute a buy transaction for an amount that equals, or is slightly greater than, the total value needed to fulfill the orders placed that day (including offsetting sales and adjustments as will be discussed). As discussed above, the system preferably waits until enough orders are placed for each holding to enable large blocks of stock to be purchased in a single transaction, which enables volume discounts to be obtained. This process is repeated for each holding represented in the portfolios that are ordered.

The system preferably has its own holding account in which a small number of shares for each holding and each portfolio can be maintained if desired. This is so that if on any given day only a small number of shares are purchased for any particular holding, the system can transfer the shares from the holding account to the purchaser's account. This way, the system would not be required to buy stocks in small volumes (without the volume discounts). The system can also be set up so that a predetermined number of shares is maintained in the holding accounts, such that any excess shares would then be distributed in response to the purchase orders. In this respect, for any particular holding, the total amount of shares to be purchased can be reduced by the number of shares that are available for distribution from the holding account.

Once the purchase transactions have been carried out, the system allocates and assigns the appropriate number of shares to the individual investment accounts (of the investors who have placed orders that day), based on their original investment amounts. The purchasing processes discussed above, and the information derived from them, such as the number of shares of stock to be purchased, and the value of the stock that each investor purchases, are preferably saved in the system so that they can be used to allocate and distribute the holdings into the appropriate investment accounts after the transactions are carried out.

For example, with respect to the second example given above, where investor one invests $10,000 in each of portfolios one and two, investor one would be entitled to the following allocation and distribution: $1,000's worth of holding A, $1,500's worth of holding B, $5,000's worth of holding C, $2,500's worth of holding D, $2,000's worth of holding E, $1,500's worth of holding F, $1,500's worth of holding G, $2,500's worth of holding H and $2,500's worth of holding I, all totaling $20,000. Investor two, who invested $5,000 in portfolio two, would be entitled to the following allocation and distribution: $1,000's worth of holding C, $750's worth of holding F, $750's worth of holding G, $1,250's worth of holding H, and $1,250's worth of holding I, all totaling $5,000. Finally, investor three, who invested $20,000 in portfolio three, would be entitled to the following allocation and distribution: $5,000's worth of holding D, $5,000's worth of holding H, $3,000's worth of holding J, $3,000's worth of holding K, and $4,000's worth of holding L, all totaling $20,000.

The system then calculates the number of shares each investor will own based on the value of each share at the time the transaction is made. This is done by dividing the total value of each holding that each investor owns by the price per share, wherein the total number of shares owned by each investor is determined. In this respect, the system preferably distributes and allocates fractions of shares where needed to enable the actual value of each holding to equal or nearly equal the percentage that each holding represents of the total amount invested in the particular portfolio. For example, if holding E has a stock price of $17.00, investor one, who bought $10,000's worth of portfolio one, would own about 117.65 shares of holding E, which equals a value of almost exactly $2,000 (i.e., 20% of $10,000). Likewise, if holding A has a stock price of $50.00, investor one would own 20 shares of holding A, resulting in a value of $1,000 (10% of $10,000).

When the number of shares owned by each investor of each holding is determined, the appropriate number of shares is allocated to each investor account and then transferred into each individual account. For example, after the calculations have been made, the system will know the total number of shares of stock (and fractions of shares) that each investor has purchased of any particular holding, wherein the appropriate number of shares for each holding (represented in each portfolio purchased by the investor) can then be allocated and distributed into the appropriate investor accounts. The system is preferably capable of calculating and automatically allocating the appropriate number of shares into each investment account, based on their purchase decisions and original investment amounts.

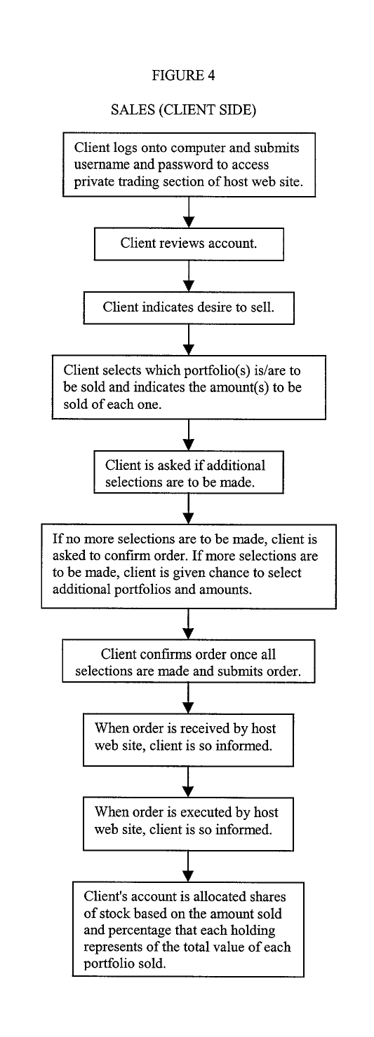

When a particular investor decides to sell all or a portion of a particular portfolio, the system preferably provides a means of prompting the investor to indicate which portfolio and how much of the money in that portfolio should be sold. As shown in FIG. 4, the investor simply selects the portfolio and the value amount to be sold, and then processes the order in much the same way that a purchase would be conducted. The order is preferably submitted using a shopping cart, wherein the investor can see the orders that have been placed, so that the order can be approved or disapproved, and corrections can be made before submitting the order.

Once an order to sell is submitted, the system preferably registers and saves each order that comes in that day and waits until enough orders have come in to carry out the sales transactions. Again, this enables the host operator to maximize volume discounts that are available by selling stock to clearing houses in large blocks.

As with purchase transactions, the system preferably screens each sale order placed that day to determine which portfolios are to be sold and the amount to be sold of each one. In this respect, as with purchase transactions, for each portfolio that is to be sold, the system obtains the percentages that each holding represents (as set by the portfolio managers) and determines the total value that needs to be sold of that holding (for any particular portfolio). This is repeated for each order that is placed. Then, the total amounts for each order placed that day are added up to determine the total number of shares that need to be sold of any particular holding. As with purchase transactions, various methods of carrying out this procedure are possible.

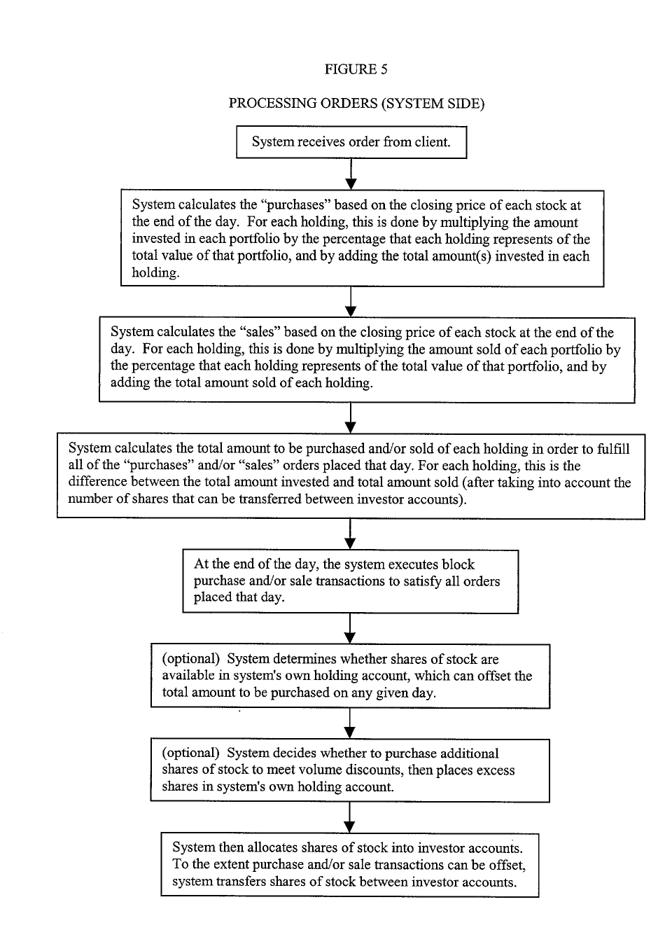

Given that many purchase and sale orders are likely to occur on any given day, the system is preferably adapted to determine the difference between the amount to be purchased and the amount to be sold, so that only the amount needed to fulfill the orders placed that day are carried out, as shown in FIG. 5. For example, once the total number of shares that are to be purchased and sold that day for a particular holding is determined, i.e., at the end of the day, the system determines the difference between the two amounts. If there are more shares to be purchased than sold for any particular holding, the amount to be sold is subtracted from the amount to be purchased, and the total amount to be “purchased” is determined. On the other hand, if there are more shares to be sold than purchased for any particular holding, the amount to be purchased is subtracted from the amount to be sold, and the total amount to be “sold” is determined. Again, the system screens through all of the orders to determine how many shares of a particular holding are to be purchased and/or sold after all of the orders have been placed that day. Either of the methods described above, as well as any other screening method, can be applied to make this determination.

The present invention contemplates that investors will be required to pay a fee each time a purchase or sale order is placed to pay for the expense of operating the system. Preferably, the fees are based on a percentage of the investment amount for each order placed. They can also be based on a graduating scale so that when a relatively large amount of money is invested by an investor, the fees as a percentage of assets can be made lower. That is, the percentages can be adjusted so that an investor who invests a relatively large amount of money pays a lower fee as a percentage of assets than an investor who invests a relatively small amount of money.

The system is also adapted to enable the portfolio managers to change the portfolios at any time, as indicated in FIG. 1. For example, whenever one of the portfolio managers decides to make a change in a portfolio, whether it involves a change in the holdings, or a percentage of the holdings, the portfolio manager simply notifies the host operator that a change is needed. To do this, using his or her own computer or network connection, the portfolio manager can simply log onto the special administration page of the host web site and use the ID and password that he or she is given to allow him or her to enter into a restricted site made available only to that portfolio manager. At that section of the site, the portfolio manager is prompted to select which portfolio is to be changed and to enter the changes that are desired. For example, a portfolio manager may decide to change the percentages by increasing the percentage of one holding and reducing the percentage of another holding. The portfolio manager may also choose to delete an existing holding, and replace it with a new holding, or can make any combination of these changes.

These changes can be made periodically by the portfolio managers as dictated by changes in the market. These changes can occur quite frequently, insofar as the market can fluctuate heavily, wherein the portfolio managers are then able to make appropriate decisions that can affect the investments of the many clients that have accounts handled by the manager.

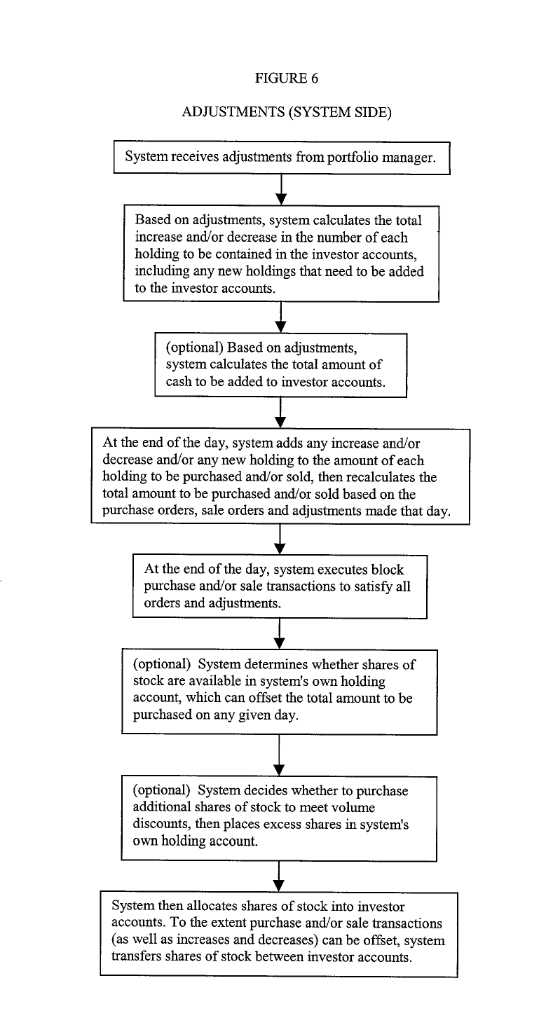

When the portfolio manager submits the desired changes, he or she initiates the process by which changes are automatically made not only to the portfolios and holdings that are offered on the host web site, but also the transactions and ownership allocations in each investment account affected by the change. That is, when the changes are made, the system implements the appropriate stock transactions to account for the changes in the investment accounts containing that portfolio. What this means is that in conjunction with all other orders placed that day, the system must also carry out additional purchase and sale transactions as necessary to account for the changes that have occurred to the portfolios and existing accounts, as a result of the changes made by the portfolio managers, as shown in FIG. 6.

For example, with respect to the second example given above, the portfolio manager may decide to change portfolio one by decreasing holding C from 30% to 20% and applying half (5%) to holding A and half (5%) to holding B. This may be a result of, for example, a less than expected earnings report from company C, or some other event affecting that company. This change would have the effect of changing the percentages of the holdings contained in portfolio one, but also the values and shares contained in each investor account containing that portfolio. In the example above, investor one's holdings would be changed to the following (assuming that the stock prices have remained unchanged): the value owned by investor one of holding A would be increased from $1,000 to $1,500, and the value of holding B would be increased from $1,500 to $2,000, while the value of holding C would be reduced from $5,000 to $4,000 (i.e., there will be a reduction of $1,000, from $3,000 to $2,000, resulting from changes to portfolio one, and no reduction relating to portfolio two). All of the other holdings would remain unchanged.

In practice, a change in value amounts would be represented by a change in numbers of shares (that make up the holdings). For example, if investor one originally owned 20 shares of holding A, he or she would then own 30 shares of holding A after the change is made. Likewise, if investor one originally owned 60 shares of holding B and 100 shares of holding C, he or she would then own 80 shares of holding B and 80 shares of holding C after the change.

Using the example above, if on the same day that investor two buys $5,000 worth of portfolio two (shown above), portfolio one is changed as indicated, the following transactions would automatically be made in connection with investors one and two: Additional shares of holding A would have to be purchased to increase holding A's percentage from 10% to 15%, i.e., from $1,000's worth of stock in holding A to $1,500's worth of stock, or from 20 shares to 30 shares (which would then be allocated to investor one). Additional shares of holding B would also have to be purchased to increase holding B's percentage from 15% to 20%, i.e., from $1,500's worth of stock in holding B to $2,000's worth of stock, or from 60 shares to 80 shares (which would also be allocated to investor one). With respect to holding C, however, the system would have to consider the reduction resulting from the change in portfolio one, and the increase resulting from investor two's $5,000 purchase of portfolio two. In this respect, the system would calculate the difference between the amount needed to be sold resulting from portfolio one's reduction from 30% to 20%, i.e., $1,000's worth of stock in holding C (in portfolio one for investor one), and the amount that has to be purchased, i.e., $1,000's worth of stock in holding C, as a result of investor two investing $5,000 in portfolio two (in which holding C still represents 20%). Doing the calculations, the system would then determine that for holding C, the purchase and sale amounts would offset each other, so that the system would not be required to buy or sell any shares of holding C, but rather, it would simply transfer $1,000's worth of holding C (in portfolio one) from investor one to investor two (in portfolio two). There would be no change in holdings D and E, and the number of shares that would have to be purchased of holdings F, G, H and I would also remain unchanged (from that shown above).

In actual practice, specific transfers like the one discussed above would not be made without taking into consideration each and every order placed that day. That is, the system would calculate the total amount of reductions (sales) and increases (purchases) effected by all of the orders placed that day, as well as any changes that are made by the portfolio managers, wherein the totals would then be calculated so that only a single transaction would have to occur for each holding. In the example above, the system would calculate the total number of shares of each holding that would need to be purchased or sold, after all of the orders are placed that day, wherein the percentage change in holding C in portfolio one (from every account containing that portfolio in the system) would then be compared to the total amount purchased and/or sold of both portfolios one and two (since they both contain holding C), to determine whether and to what extent shares of holding C would have to be purchased or sold that day. In this respect, whether holding C would have to be purchased or sold would depend on how many investors buy portfolios one and two, how many investors sell portfolios one and two, and the changes made in portfolio one.

For these reasons, on any given day, the purchase and sale transactions, and any changes made by portfolio managers that day, are preferably screened to determine the total amounts that must be purchased or sold for any given holding at the end of the day. In this respect, the system preferably generates three totals for each holding, i.e., the total to be purchased based on orders placed that day (for all portfolios containing that holding), the total to be sold based on orders placed that day (for all portfolios containing that holding), and the total to be purchased or sold depending on what changes have been made to the portfolios (containing that holding) made by the portfolio managers. These three amounts are added up (the sales are subtracted from the purchases) to determine the total value that needs to be purchased or sold with respect to any particular holding. The number of shares that must be purchased or sold is also determined by dividing the per share price into the total value obtained.

The system preferably enables the host operator to review and approve a change made and submitted by the portfolio manager, although the system is also capable of automating the changes to bypass the host operator if desired. And, the system is preferably adapted so that by making a single change, the system automatically makes that change in every account in the system that contains that portfolio. For example, if 5000 investors have invested in portfolio one, a single change to that portfolio will affect changes in all 5000 accounts, wherein the changes are first executed by carrying out the transactions, and then allocated and distributed into the accounts as changes.

The system is preferably adapted so that when a change occurs, the system automatically notifies every account holder affected by the change by email or other communication. The communication preferably indicates that a change has been made in the portfolios designated and the percentages and holdings that are affected. The changes are also preferably automatically made in the accounts themselves. That is, when an investor goes into the web site and reviews his or her account, the appropriate changes to the number of shares and values in any particular holding will be indicated. The transaction date and amount of money affected by the changes, as well as the purchase and sale prices, and cost basis, are also preferably provided.

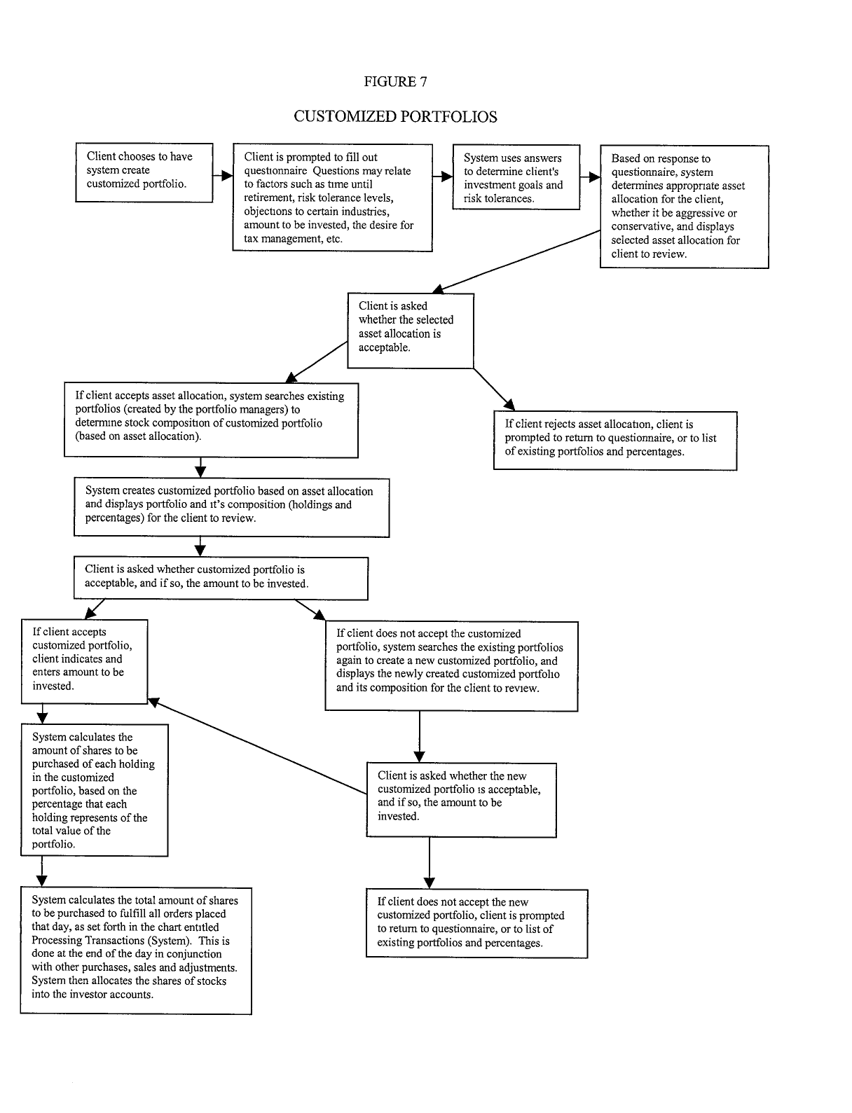

In an alternate embodiment of the present invention, as shown in FIG. 7, the system is able to offer customized portfolios designed from a database of prescreened stocks and mutual funds according to customer preferences. In this respect, at the time the investor reviews the portfolios offered online, the investor can choose not to make a choice, and can then be prompted to fill out an online questionnaire to indicate his or her investment goals and risk preferences, etc., so that the system can develop a customized stock portfolio, which can include mutual funds, for that particular investor's preferences.

The questionnaire can have questions relating to factors such as time until retirement, risk tolerance levels, objections to certain industries (i.e., tobacco, alcohol, etc.), amount to be invested, the desire for tax management, etc. Based on the results of the questionnaire, an appropriate asset allocation is preferably determined to create a customized portfolio for that investor. For instance, an aggressive asset allocation could consist of 30% large caps, 40% small caps, 30% international stocks, and 0% bonds or cash. On the other hand, a more conservative asset allocation could have 60% large caps, 20% small caps, 20% bonds or cash.

Once an appropriate asset allocation is determined, the system will construct a concentrated portfolio for the client with holdings taken from the various asset classes matching the determined asset allocation. For example, for small investors (less than $250,000 in assets), the resulting portfolio could include 20 to 30 stocks (the bond or cash component will be a bond fund, or money market fund, however), and the number of stocks can rise with the amount of assets up to a preferred maximum of 30 stocks. The stocks included in each asset class can be chosen from the portfolios managed by the portfolio managers, i.e., the most popular holdings in those portfolios within the asset classes can be selected. For example, if the system contains five portfolios run by portfolio managers that are focused on large cap stocks, then the system will preferably choose a preselected number of the most popular stocks from those portfolios. That is, the system can select the top five, six, or seven holdings in that asset class (depending on what the client's asset allocation determination suggests) for inclusion in the portfolio. The system will then do the same thing for the small cap component, and then the international component, etc. Any bond holdings or cash will be accommodated using a bond fund or money market fund.

The system also preferably allows mutual funds to be added to the customized portfolios. This is particularly useful when clients only have a small amount of money to invest, wherein the process of selecting individualized portfolios may be too costly in proportion to the potential fees that can be generated. Part of the asset allocation recommended to such investors could include, for example, mutual funds as part of the small caps, large caps, or any other portion of the allocation.

The system preferably allows each investor to make decisions about the allocations and portfolios that are constructed. For example, the investor can reject the asset allocations determined by the system and be prompted to return to the list of existing portfolios, or to the questionnaire, if desired. On the other hand, if the investor accepts the asset allocations, the system searches the database of existing portfolios to create a new customized portfolio for the client (based on the asset allocations as described above), wherein the investor can then choose to purchase the portfolio, if desired, and indicate the amount to be invested. The system can also be made to provide information about the holdings that are selected and why they were chosen. Once the order is placed, information regarding the value and number of shares to be bought and/or sold of any particular holding, in relation to all customized orders placed that day, is then combined with the information for all buy and sell orders that day, as well as changes to the portfolios described above, so that the appropriate number of shares of that holding can be bought or sold at the end of the day.

The system is also preferably designed so that when the holdings or percentages in the managed portfolios (upon which the customized portfolios are based) are changed, as discussed above, then those changes will automatically result in changes to the customized asset allocation portfolios as well. For example, if there are changes made to one or more of the managed portfolios (upon which the customized portfolios are based), which alters the top holdings in the applicable asset classes (or their percentages), indicating that a change should be made to the customized portfolios, then those changes are automatically made simply by having the portfolio managers make changes to the managed portfolios, wherein those changes are then automatically indicated in the investor accounts containing the customized portfolios.

The above description has been provided as a means of describing some of the preferred embodiments of the present invention. It is not, however, intended to describe each and every embodiment that could potentially be developed that is within the contemplation of the invention. Additional embodiments which may comprise features not described here are within the contemplation of the invention.

What is claimed is:

1. A computer operated method comprising:
creating or having created one or more stock portfolios, each having two or more holdings;
determining or having determined the percentage that each holding represents of the total value of each portfolio;
displaying said portfolios and percentages for each portfolio and making said portfolios available to investors on a computer operated network site;
enabling said investors to create accounts using said network site;
enabling said investors to choose which stock portfolio or portfolios to purchase, and how much money to invest in each one, wherein by investing money in a particular portfolio, an investor becomes an owner of stock in the holdings contained in said portfolio, wherein the number of shares of stock of each holding that is purchased by said investor is based on the total amount invested by said investor in said portfolio, and the percentage that each holding represents of the total value of said portfolio; and
allocating the appropriate number of shares of stock purchased by said investors into said accounts.

2. The method of claim 1, wherein the method comprises creating or having created one or more stock portfolios each containing less than 30 holdings.

3. The method of claim 1, wherein the step of making said one or more portfolios available to said investors comprises listing said portfolios and providing information about each portfolio and its holdings on said computer operated network site.

4. The method of claim 1, wherein the method comprises enabling said investors to use an online payment application to pay for said investments.

5. The method of claim 1, wherein the method comprises setting up an account for each investor that has been approved through a registration process.

6. The method of claim 1, wherein the method comprises calculating the total number of shares of each holding to buy from a stock clearing house, and waiting a predetermined period of time before buying said shares from said stock clearing house, wherein volume discounts can then be obtained.

7. The method of claim 1, wherein the method comprises enabling said investors to choose which stock portfolios to sell, and how much to sell of each one, wherein the number of shares of stock in each holding that remains in said accounts will be based on the total dollar amount sold of each portfolio, and the percentage that each holding represents of the total value of each portfolio sold.

8. The method of claim 7, wherein the method comprises calculating the number of shares of stock to transfer between accounts, and the total number of shares of stock of each holding to buy and/or sell, based on said purchases and sales, and waiting until a predetermined time before buying and/or selling shares of stock, wherein volume discounts can then be obtained.

9. The method of claim 7, wherein the method comprises having a portfolio manager adjust one or more of said portfolios, by adjusting the holdings and/or the percentages that they represent of the total value of said portfolios.

10. The method of claim 9, wherein the method comprises calculating the number of shares of stock to transfer between accounts, and the total number of shares of stock of each holding to buy and/or sell, based on the combination of said purchases, sales and adjustments, and waiting until a predetermined time before buying and/or selling shares of stock, wherein volume discounts can then be obtained.

11. The method of claim 10, wherein the method comprises allocating the appropriate number of shares of stock that has been bought and/or sold and/or transferred into the appropriate accounts.

12. The method of claim 10, wherein the method takes into account the number of shares that are available in a system holding account in calculating the number of shares of each holding to buy and/or sell.

13. The method of claim 10, wherein the method comprises buying more shares of stock than needed to fulfill the purchase orders, so that volume discounts can then be obtained, wherein the excess shares can be placed in a system holding account.

14. The method of claim 1, wherein the method comprises assessing fees that are owed by said investors as a percentage of the total amount invested, wherein said percentage is capable of being adjusted depending on the amount invested.

15. A computer operated system comprising:
a computer operated subsystem adapted to enable one or more stock portfolios to be created, and to enable the percentage that each holding represents of the total value of each portfolio to be determined;
a computer operated second subsystem adapted to display said one or more stock portfolios and said percentages, and make said portfolios available to investors on a computer operated network site;
a computer operated third subsystem adapted to enable said investors to become registered and create accounts;
a computer operated fourth subsystem adapted to enable said investors to choose which stock portfolios to invest in, and how much money to invest in each one, wherein by investing money in a particular portfolio, an investor can become an owner of stock in the holdings contained in said portfolio, wherein the number of shares of stock owned by said investor in said holdings is based on how much was invested in said portfolio, and the percentage that each holding represents of the total value of said portfolio;
a computer operated fifth subsystem adapted to process the selections made by said investors and execute the orders that have been placed at a predetermined time; and
a computer operated sixth subsystem adapted to allocate the number of shares of each holding purchased by said investors into said accounts.

16. The system of claim 15, wherein said fourth subsystem is adapted to enable said investors to choose which stock portfolios to sell, and how much to sell of each one, wherein the number of shares of stock in each holding that remains in said accounts will be based on the total dollar amount sold of each portfolio, and the percentage that each holding represents of the total value of each portfolio sold.

17. The system of claim 16, wherein said system is adapted to execute the sales orders that have been placed, and then allocate the number of shares of each holding sold by said investors from said accounts.

18. The system of claim 17, wherein said system is adapted to allow a portfolio manager to adjust the holdings and/or percentages that each holding represents of the total value of each portfolio.

19. The system of claim 18, wherein said system is adapted to execute the orders that are needed to account for the adjustments, and enable the number of shares of each holding to be appropriately allocated into said investors' accounts after said adjustments are made.

20. The system of claim 19, wherein the system is adapted to calculate the total number of shares of stock in each holding to buy and/or sell, based on the adjustments that have been made by said portfolio manager, and/or based on the purchase and/or sale orders placed by said investors, taking into account the number of shares that can be transferred between accounts to offset the number of shares to be purchased and/or sold.

21. The system of claim 20, wherein the system is adapted to wait until a predetermined time before buying and/or selling shares of stock from a stock clearing house, wherein volume discounts can then be obtained.

22. The system of claim 15, wherein the system is adapted to enable said investors to own fractions of shares of stocks.

23. A method of purchasing and selling shares of stock using a computer operated network comprising:
accessing a network site and becoming a registered user;
receiving an account;
reviewing one or more stock portfolios on said site, each of said portfolios containing two or more holdings;
purchasing one or more stock portfolios and indicating the monetary value to be invested in each one, wherein the number of shares of stock to be owned is based on the total amount invested in each portfolio, and the percentage that each holding represents of the total value of each portfolio; and
receiving an ownership allocation of the appropriate number of shares of stock purchased into said account.

24. The method of claim 23, comprising submitting financial account information and obtaining pre-approval to become a registered account holder.

25. The method of claim 23, comprising deciding to sell all or a portion of one or more of said portfolios that have been purchased and indicating the monetary value to be sold of each one using said network site.

26. The method of claim 25, receiving an allocation of the appropriate number of shares of stock that have been purchased and/or sold.

27. The method of claim 38, comprising receiving an adjustment in the number of shares of stock that are held in said account, wherein said adjustment is made by a portfolio manager and is based on changes to the holdings and/or the percentages that each holding represents of the total value of the portfolio or portfolios that have been purchased.

28. The method of claim 27, comprising receiving an allocation of the appropriate number of shares of stock held in said account based on the adjustments that have been made by said portfolio manager.

29. The method of claim 23, comprising paying for said purchase with a credit card and using a payment processing application available on said network site.

30. The method of claim 23, comprising being charged a fee for said purchase as a percentage of the total amount invested, wherein said percentage is adjustable depending on the amount invested.

31. A computer operated method comprising:
having an investor fill out a questionaire to determine the investor's goals and risk tolerances, and using the responses to the questionaire to determine an appropriate asset allocation for said investor;
displaying said asset allocation on a computer operated network site for the investor to review and allowing said investor to decide whether said allocation is acceptable;
searching one or more existing portfolios created by a portfolio manager to determine the appropriate customized portfolio composition, and then creating a customized portfolio based on said asset allocation and said composition;
displaying said customized portfolio and its composition for the investor to review and allowing said investor to decide whether said customized portfolio is acceptable;
allowing said investor to indicate the amount to be invested in said customized portfolio;
calculating the number of shares to be purchased of each holding in said customized portfolio, based on the amount invested and the percentage that each holding represents of the total value of said customized portfolio;
executing the purchase orders needed to fulfill the orders placed by said investor; and
allocating the total number of shares purchased by said investor into an account set up for said investor, wherein said investor becomes an owner of stock in the holdings contained in said customized portfolio.

32. The method of claim 31, wherein said questionaire relates to one or more of the following factors: time until retirement, risk tolerance levels, objections to certain industries, amount to be invested, and the desire for tax management.

33. The method of claim 31, wherein said asset allocation comprises percentages for one or more of the following investment categories: small cap, mid cap, large cap, international stocks, bonds, and cash.

34. The method of claim 31, wherein the method comprises the step of allowing said investor to reject said asset allocation, wherein said investor is prompted to return to said questionaire.

35. The method of claim 31, wherein the method comprises the step of allowing said investor to reject said customized portfolio, wherein the method comprises searching said one or more existing portfolios again to determine the appropriate customized portfolio composition, and creating a second customized portfolio based on said asset allocation and said composition.

36. The method of claim 35, wherein the method comprises the step of displaying said second customized portfolio and its composition for the investor to review and allowing said investor to decide whether said second customized portfolio is acceptable.

37. The method of claim 31, wherein said customized portfolio is created by selecting one or more holdings contained in said one or more existing porfolios for each asset class in said asset allocation.
